(19) United States
(12) Patent Application Publication
(10) Pub. No.: US 2022/0271330 A1
(43) Pub. Date: Aug. 25, 2022

(54) SODIUM SILICATE SOLID-STATE ELECTROLYTE MATERIAL

(71) Applicant: Geometric Energy Corporation, Calgary (CA)

(72) Inventors: Sumaletha Narayanan, Calgary (CA); Shantel Butler, Calgary (CA); Samuel Reid, Calgary (CA); Sourav Bag, Calgary (CA); Venkataraman Thangadurai, Calgary (CA)

(21) Appl. No.: 17/636,812

(22) PCT Filed: Aug. 21, 2020
(86) PCT No.: PCT/CA2020/051149

§ 371 Date: Feb. 18, 2022

Related U.S. Application Data
(60) Provisional application No. 62/889,879, filed on Aug. 21, 2019.

(51) Int. Cl. H01M 10/0562; H01M 10/054

(52) U.S. Cl. CPC H01M 10/0562; H01M 10/054; H01M 2300/0071

(57) ABSTRACT

Materials, methods and uses for sodium silicate solid electrolyte materials, their methods of production, and their use in electrochemical cells. A solid electrolyte has the chemical composition NaₓMₓSiₓ0ₓ, wherein M is Gd or Y, wherein x is an integer between 1 and 10, characterized in that it has a conductivity of at least 10⁻⁴ Scm⁻¹ at 20° C., and is electrochemically stable at a current density of 0.01 mA cm⁻² for at least 100 cycles. The glass ceramic has characteristics demonstrating that it is useful as a solid-state electrolyte in sodium ion batteries and in other technologies demanding a stable sodium ion conductor

### FIELD

Embodiments of the disclosure relate to sodium silicate solid electrolyte materials, their methods of production, and their use in electrochemical cells.

### BACKGROUND

High energy density rechargeable battery systems are a highly sought technology objective because of the proliferation of power-consuming portable electronics that demand increasingly greater energy levels, as well as more interest in practical hybrid and electric-powered vehicles with significantly improved range presently unavailable from lead acid batteries. Batteries incorporating lithium ion (Li-ion) based technologies are widely used due to the high energy density of Li-ion batteries owing to the small atomic weight and high ionization density of lithium.

Many Li-ion based technologies incorporate organic solvents contained in liquid electrolyte. Many of the organic solvents utilizable for such applications have a low flash point and a high flammability, and thus have hazards of ignition, explosion, etc. due to overcharging, heating, etc. To address safety issues, the development of non-highly flammable liquid electrolytes have been investigated. Alternatively, the development of solid electrolytes, consisting of non-flammable materials used in place of conventional liquid electrolytes is also being investigated.

Lithium itself is expensive and its procurement and disposal raises many environmental concerns. In contrast, sodium is both less expensive and ubiquitous as a natural resource.

Na-β alumina is a widely used ceramic electrolyte separator in currently available commercial sodium batteries, which operate at high temperature, e.g., at 300° C. A class of compounds called sodium super ionic conductor (NASICON) type ceramics, with stoichiometry, Na₃Zr₂Si₂PO₁₂, exhibit promising ionic conductivity of 10⁻³ Scm⁻¹ at room temperature, resulting in an optimal electrolyte for solid-state sodium ion batteries. Sulfide based materials have been investigated but have found to be unstable with sodium metal and ambient atmosphere. A recent study on perovskite-type sodium ion conductors, Na_{0.33}La_{0.55}ZrO₃ analogue of lithium lanthanum titanates, was reported by Zhao et al. and shows sodium ion conductivity of 1×10⁻⁵ Scm⁻¹ at 25° C.

Rare earth silicates, Na₅MSi₄O₁₂ (M=rare earth elements, Gd and Y) are a class of materials which have not been studied much since their discovery in the 1970s. Na₅MSi₄O₁₂ was synthesized by solid-state synthesis accompanied by high temperature quenching, freeze drying, hydrothermal or sol-gel techniques. A recent study by Okura et al. evaluated the effect of V and Mo substitution at the Si site of Na₅YSi₄O₁₂ on phase separation and microstructural change of this glass ceramic. The common secondary phases observed in the X-ray diffraction patterns of Na₅MSi₄O₁₂ compositions are Na₃GdSi₃O₉ and Na₉GdSi₆O₁₈. There has been limited research on these secondary phases.

There is an ongoing need for sodium ion-based solid-state electrolytes that exhibit suitable physical and electrical properties at operating temperatures near room temperature.

### SUMMARY

Disclosed herein are glass ceramics comprising of sodium silicate, including their methods of production, that are suitable for use as solid-state electrolytes in electrochemical and battery applications at room temperature.

In a broad aspect, a solid electrolyte has the chemical composition NaₓMₓSiₓ0ₓ, wherein M is Gd or Y, wherein x is an integer between 1 and 10, characterized in that it has a conductivity of at least 10⁻⁴ Scm⁻¹ at 20° C., and is electrochemically stable at a current density of 0.01 mA cm⁻² for at least 100 cycles.

In an embodiment, the electrolyte has the chemical composition NaₓGdₓSiₓ0ₓ.

In an embodiment, the electrolyte has the chemical composition Na₃GdSi₃O₉. In an embodiment, the electrolyte has the chemical composition Na₄GdSi₃O₉.

In an embodiment, the electrolyte has the chemical composition NaₓYₓSiₓ0ₓ.

In an embodiment, the electrolyte has the chemical composition Na₃YSi₃O₉.

In an embodiment, the electrolyte has a PXRD pattern as shown in FIG. 2.

In an embodiment, the electrolyte has a PXRD pattern with characteristic peaks at 22, 33 and 34 two theta.

In an embodiment, the electrolyte has an Archimedes density of about 3.4 gcm-3.

In an embodiment, the electrolyte is produced by: mixing a mixture of precursors comprising sodium, silicon, oxygen and gadolinium for about 6 hours at about 200 rpm in high energy ball mill, optionally with additional sodium compound; heating the mixture to about 900° C. for about 6 hours; mixing the resultant mixture in high energy ball mill in an organic solvent for about 6 hours at about 200 rpm; pressing a resultant powder into pellets by isostatic pressing; heating the pellets for about 6 hours at about 1050° C. with a heating rate of about 5° C. per minute; and air sintering or quenching the pellets.

In an embodiment, the compounds used to produce the electrolyte comprise sodium, silicon, oxygen and gadolinium are NaNO₃, Gd₂O₃ and SiO₂, and the solvent is isopropanol.

In an embodiment, the solid electrolyte is used as a membrane electrolyte in electrochemical and battery applications.

In an embodiment, a battery comprises the solid electrolyte.

### BRIEF DESCRIPTION OF THE DRAWINGS

FIG. 1 shows the powder X-ray diffraction (PXRD) pattern of Na₃GdSi₃O₉ synthesized at 1050° C. in air via a solid-state method. The reference PXRD patterns of Na₃GdSi₃O₉, powder diffraction file (PDF) 00-035-0142, and possible secondary phases (Na₅GdSi₄O₁₂, PDF 00-035-0141; Na₉GdSi₆O₁₈, PDF 00-056-0122; Na₃GdSi₂O₇, PDF 00-056-0185; NaGdSiO₄ Orthorhombic, PDF 00-035-0013; and NaGdSiO₄ Tetragonal, PDF 00-035-0012) are also provided for comparison.

FIG. 2 shows PXRD patterns of Na₃GdSi₃O₉ synthesized at 1050° C. via solid-state methods, specifically air sintering and quenching methods.

FIG. 3 shows scanning electron micrographs (SEM) of Na₃GdSi₃O₉ synthesized (at 1050° C.) by air sintering with controlled cooling (left) and air sintering and quenching (right).

FIG. 4 is line scanning (right) of Na₃GdSi₃O₉ showing the elemental distribution across the cross-sectional area of the micrograph (left).

FIG. 5 shows alternating current (AC) impedance spectra of Na₃GdSi₃O₉ at 20° C. for the air-sintered (left) and quenched (right) pellets. The symbols and solid lines indicate the measured and fitted data, respectively. Gold (Au) electrodes were used as the current collectors on both sides of the pellet and impedance was measured in the range of 0.1-1 MHz. The inset figure shows the equivalent circuit used to fit the data.

FIG. 6 shows AC impedance spectra of Na₃GdSi₃O₉ at higher temperatures (100-200° C.) for the air-sintered (left) and quenched (right) pellets. Au electrodes were used with current collectors on both sides of the pellet and impedance was measured in the range of 0.1-1 MHz.

FIG. 7 shows Arrhenius plots showing the electrical conductivity and temperature relationship of Na₃GdSi₃O₉ synthesized by air sintering and quenching methods. Three different batches of air sintered pellets were used to check the reproducibility of the ionic conductivity.

FIG. 8 shows the Galvanostatic cycling of Na₃GdSi₃O₉ at 0.01 mA cm⁻² at 25° C. using a Na/Na₃GdSi₃O₉/Na symmetrical cell.

### DETAILED DESCRIPTION

Embodiments, including a glass ceramic comprised of sodium silicate, its method of production, and uses are described herein. Use of the term “about” herein means+/−10% of a given value.

In one embodiment, the glass ceramic comprises sodium silicate with chemical composition NaₓMₓSiₓOₓ, wherein M represents a rare earth element, preferably a trivalent cation—preferably Gd (Gadolinium), Y (Yttrium) or Sm (Samarium), and x represents an integer between 1 and 10. Preferred embodiments of the glass ceramic have the chemical composition NaₓGdₓSiₓOₓ and NaₓYₓSiₓOₓ. Particularly preferred embodiments of the glass ceramic have the stoichiometry Na₃MSi₃O₉, including Na₃GdSi₃O₉, Na₃YSi₃O₉, or Na₄GdSi₃O₉.

The glass ceramic disclosed herein has characteristics demonstrating that it is useful as a solid-state electrolyte in sodium ion batteries and in other technologies demanding a stable sodium ion conductor. In particular, it is selectively permeable to sodium ions, substantially impermeable to water, and it is electrochemically stable. In embodiments, it has a conductivity of at least about 10⁻⁴ Scm⁻¹ at 20° C., and is electrochemically stable at a current density of 0.01 mA cm⁻² for at least 100 cycles.

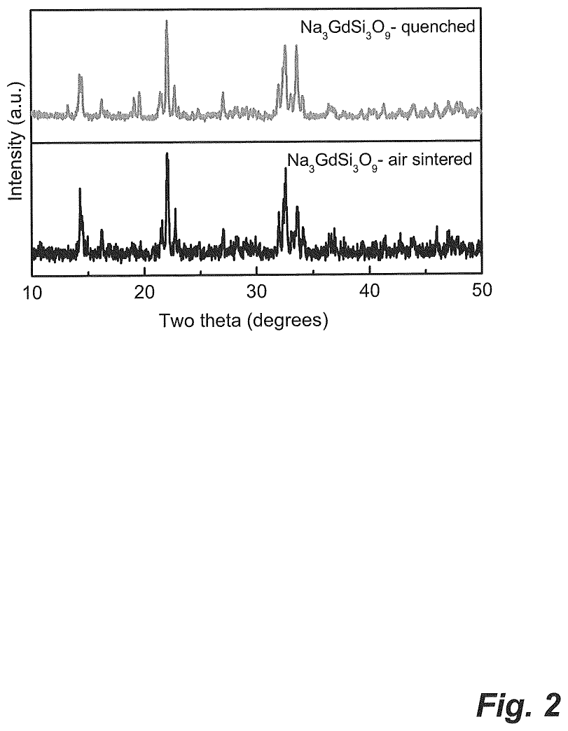

In embodiments, the glass ceramic comprises sodium, gadolinium, silicon, and oxygen in a stoichiometric ratio of Na₃GdSi₃O₉, characterized such that it has an Archimedes density of 3.4 g cm⁻³ and a PXRD pattern as shown in the top or bottom of FIG. 2. In embodiments, the glass ceramic is further characterized in that it has a stoichiometric ratio of Na₃GdSi₃O₉, an Archimedes density of 3.4 g cm⁻³ and XRPD peaks at 22, 33 and 34 two theta. In yet other embodiments the glass ceramic may be further characterized in that it has a stoichiometric ratio of Na₃GdSi₃O₉, an Archimedes density of 3.4 g cm⁻³ and a conductivity of at least about 10⁻⁴ Scm⁻¹ at 20° C.

Also provided herein is a method of production of a glass ceramic sodium silicate with stoichiometric ratio of Na₃GdSi₃O₉, which comprises the following steps:
a) mix a mixture of precursors comprising of sodium, silicon, oxygen, and gadolinium in an organic solvent for about 6 hours at about 200 revolutions per minute (rpm) in a high energy ball mill, optionally with an additional sodium compound;
b) heat the mixture to about 900° C. for about 6 hours;
c) mix the mixture in a high energy ball mill in an organic solvent for about 6 hours at about 200 rpm;
d) press a resultant powder into pellets by isostatic pressing;
e) heat the pellets to about 1050° C. for about 6 hours with a heating rate of about 5° C. per minute,
f) air sinter or quench the pellets.

In embodiments, the precursors that comprise sodium, silicon, oxygen, and gadolinium are NaNO₃, Gd₂O₃ and SiO₂, and the solvent is isopropanol.

This disclosure also provides a solid-state sodium-based rechargeable battery that is operable at relatively low temperatures, for example, at about 25° C.+/−10° C. (room temperature). The battery comprises the glass ceramic sodium silicate described herein as the sodium ion conductive electrolyte membrane, which separates a negative electrode compartment from a positive electrode compartment. The negative electrode compartment comprises a sodium metal electrode and the positive electrode compartment comprises a cathode.

The negative and positive electrode compartments can have any suitable shape, have any suitable special relationship, or have any other suitable characteristic that allows the battery to function as intended. For example, the negative and positive electrode compartments can each be tubular, rectangular, or any other suitable shape, and they can be adjacent.

The battery operates at any suitable operating temperature, generally below the melting temperature of sodium, for example below about 100° C., below about 90° C., about 80° C., about 70° C., about 60° C., about 50° C., about 40° C. or about 30° C., and in embodiments at about 25° C.+/−10° C. (about room temperature).

The sodium metal negative electrode can comprise any suitable sodium-containing negative electrode material that allows the battery to function—e.g., substantially pure sodium, impure sodium, a sodium alloy.

A detailed description of an embodiment of the glass ceramic, Na₃GdSi₃O₉, is described next.

Method of Production

Solid-state methods were used to synthesize the Na₃GdSi₃O₉ ceramic electrolyte material provided herein. The precursors NaNO₃ (98%, Alfa Aesar), Gd₂O₃ (99.9%, Alfa Aesar), and SiO₂ (99%, Alfa Aesar) were used in stoichiometric amounts based on the molecular mass of the precursors and their stoichiometry. A high energy ball mill (Pulverisette™, Fritsch, Germany) was used to mix the precursors together for about 6 hours at about 200 rpm using isopropanol. An excess of 10 wt. % NaNO₃ was added to the initial mixture to compensate for the volatile loss at higher temperatures. The mixture was initially heated at about 900° C. for about 6 hours prior to the ball milling step. The resulting powder was pressed into pellets by isostatic pressing before the final sintering. The mixture was then heated to about 1050° C. for about 6 hours with a heating rate of about 5° C. per minute to produce Na₃GdSi₃O₉. Two different sintering methods were used to produce the ceramics: (i) air sintering with controlled heating to about 1050° C. for about 6 hours and controlled cooling; and (ii) quenching with controlled heating to about 1050° C. followed by placing the pellet at room temperature to cool.

The structural analysis of the resultant Na₃GdSi₃O₉ was performed using powder X-ray diffraction (PXRD) using a Bruker™ D8 PXRD with Cu Kα radiation¹. The morphological characterization was done with a Field Emission Scanning Electron Microscope (FESEM-Zeiss Zigma™ Series). The impedance analysis was carried out using Solartron™ SI 1260 impedance and gain-phase analyzer (0.1 Hz to 1 MHz; 100 mV). For the impedance measurements, gold (Au) electrodes were painted on both sides of the pellet samples. The stripping-plating experiment was carried using sodium (Na) electrodes on both sides of pellet sample and was assembled in a coin cell. ¹ PXRD measurements of samples may contain anomalies in the amount of up to 5% of the total material.

### Sodium Silicate Solid Electrolyte Compound

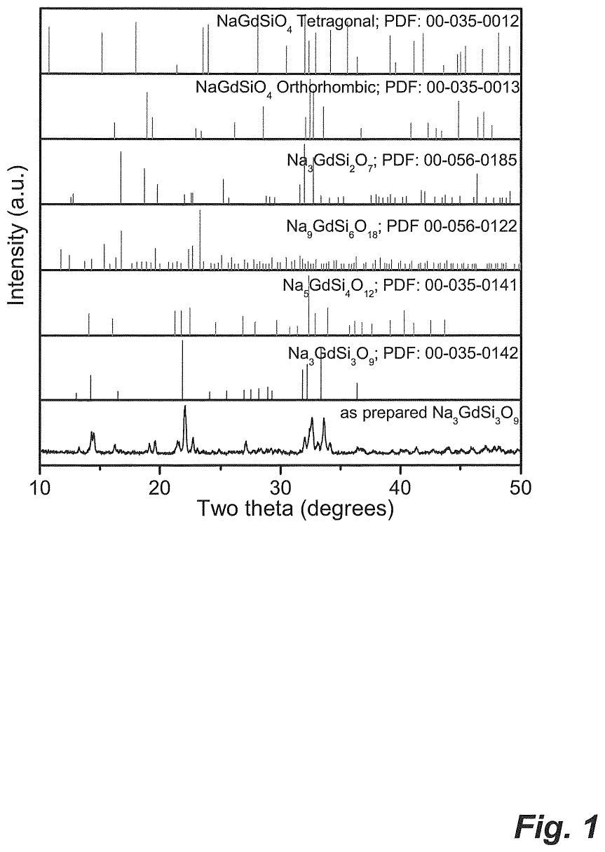

The PXRD pattern of Na₃GdSi₃O₉ synthesized by the air sintering method at 1050° C. disclosed herein is shown in FIG. 1, along with the patterns of a reference Na₃GdSi₃O₉ compound, and possible impurity phases. Analysis of the PXRD of the Na₃GdSi₃O₉ ceramic disclosed herein suggests that it is not a single phase and includes secondary peaks resulting from different rare earth silicates including Na₅GdSi₄O₁₂ (Powder diffraction file (PDF) number: 00-035-0141), Na₉GdSi₆O₁₈ (PDF: 00-056-0122), Na₃GdSi₂O₇(PDF: 00-056-0185), NaGdSiO₄ (Orthorhombic phase, PDF: 00-035-0013), and NaGdSiO₄ (Tetragonal phase, PDF: 00-035-0012). In the prior art, Na₃GdSi₃O₉ has been reported primarily as an impurity phase along with rare earth (Gd based) silicates. Na₃GdSi₃O₉ is characterized in that it secondary phase peaks as listed which overlap with the Na₃ phase.

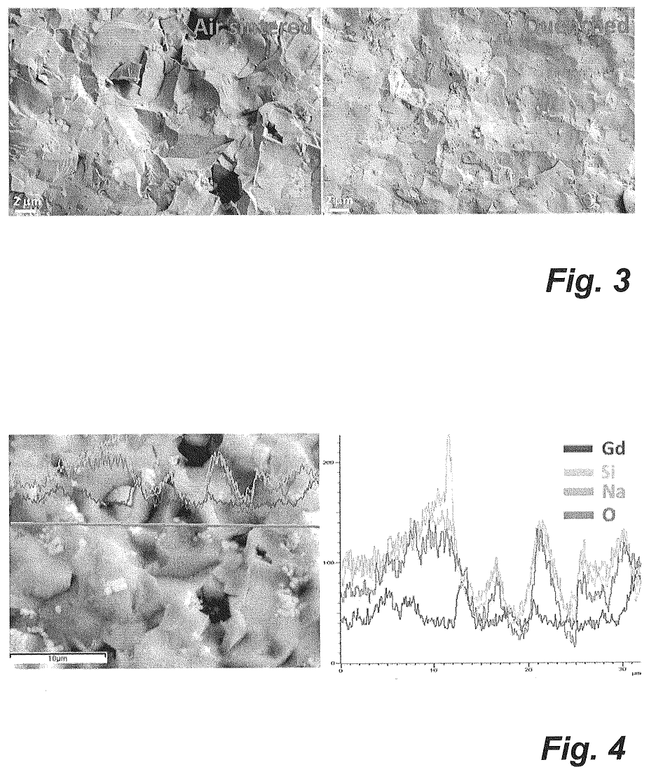

FIG. 2 illustrates the PXRD patterns of the Na₃GdSi₃O₉ ceramic synthesized at 1050° C. by a solid-state technique using air sintering (bottom) or quenching (top). FIG. 3 shows the scanning electron micrographs (SEM) of the Na₃GdSi₃O₉ ceramic synthesized by air sintering (left) and quenching (right) methods. While the surface appears highly dense in both cases, the quenched samples appear to have a diffused liquid phase. Line scanning performed on the cross section of pellets, to analyze differences in elemental distribution due to secondary phases, is illustrated in FIG. 4. Differences in the distribution of the elements Na, Gd, Si, and O were observed, supporting the observation in the PXRD patterns which indicated the presence of multiple phases ranging from less sodium containing NaGdSiO₄ to sodium rich Na₉GdSi₆O₁₈. The Archimedes density of Na₃GdSi₃O₉ was calculated to be 3.4 g cm⁻³ or about 3.4 g cm⁻³, which is higher than the reported relative density of prior art Na₃GdSi₃O₉, of 2.8 g cm³.

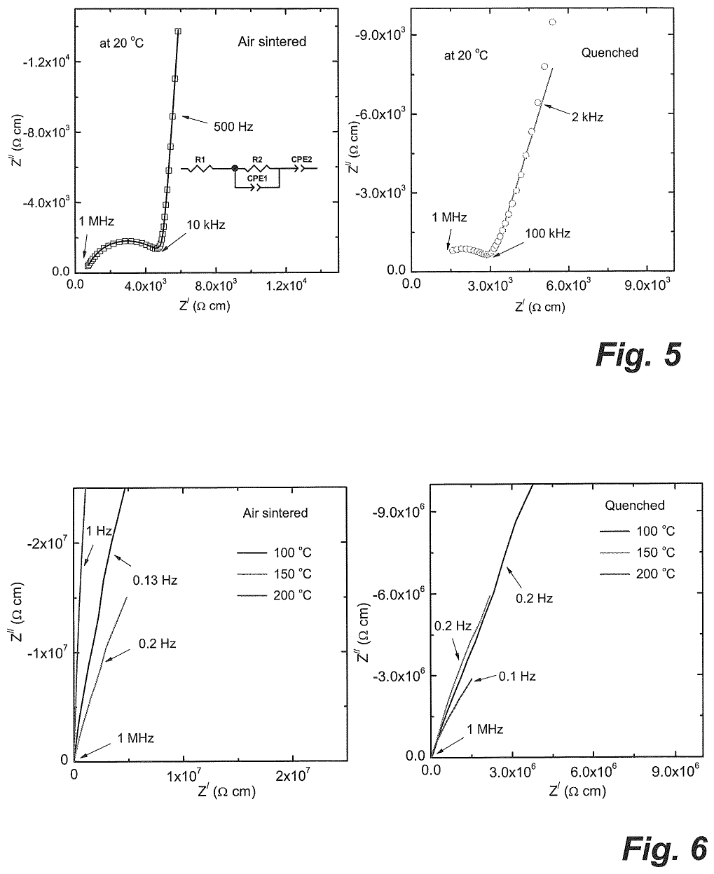

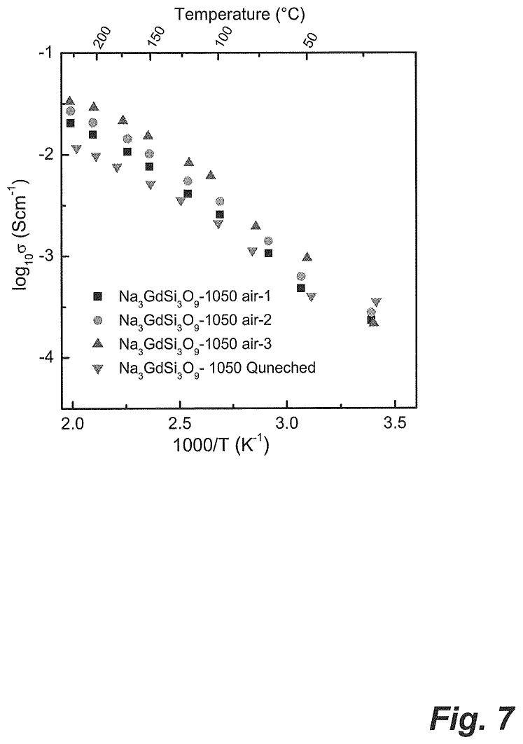

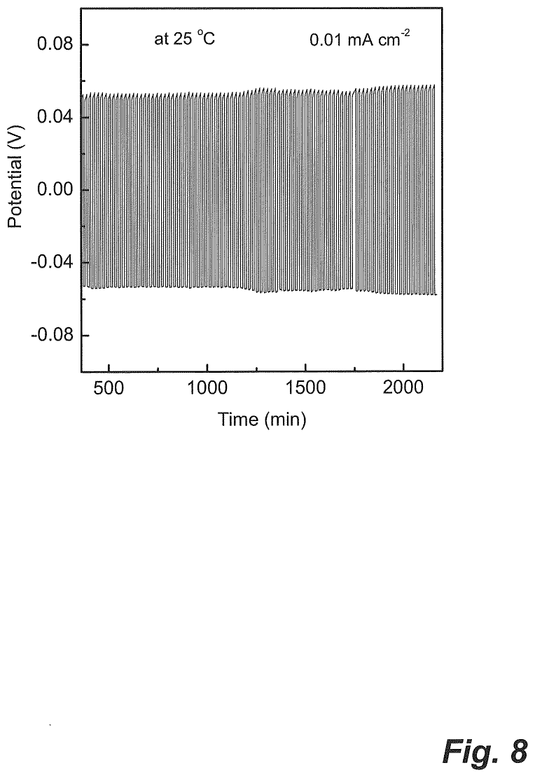

Alternating current (AC) impedance spectroscopy was used to understand the electrical properties of the Na₃GdSi₃O₉ pellets produced herein. The Nyquist plots provided in FIG. 5 are representative of the resistive characteristics of the material at a lower temperature (20° C.). The AC impedance spectroscopy graphs reveal a semicircle at higher frequencies and a tail at lower frequencies which suggests grain-boundary and blocking electrode effects, respectively. Capacitance calculated from the fitting analysis falls in the range of 10⁻⁹ to 10⁻¹⁰ Farads. High temperature impedance plots are provided in FIG. 6, and contain only a spike, making it difficult to resolve the conductivity contribution by fitting. Conductivity is therefore calculated using the equation,

$$σ = ( \frac{1}{R} ) ( \frac{l}{a} )$$

where R is the resistance at the high frequency intercept, I is the thickness of the sample, and a is the area of Au electrode. The impedance spectra of Na₃GdSi₃O₉ at high frequencies are just a spike similar to other high conducting sodium electrolytes. FIG. 7 illustrates the relationship between conductivity and temperature based on the Arrhenius equation,

$$σ T = A exp ( \frac{- {E}_{a}}{kT} )$$

where A is the pre-exponential factor, Eₐ is the activation energy, T is the temperature, and k is the Boltzmann constant (1.38×10-23 J K⁻¹). Conductivity measurements were conducted between 20 to 230° C. Both the air sintered and quenched Na₃GdSi₃O₉ pellets have a conductivity in the order of 10⁻⁴ S cm⁻¹ at 20° C. This value is higher than that previously reported for Na₃GdSi₃O₉ silicates. The conductivity values suggest that quenching or spray freezing (a prior art method to synthesize NaGd silicates) is not required to synthesize the Na₃GdSi₃O₉. Room temperature conductivity is similar in air-sintered and quenched samples. However, the air sintered samples had higher conductivity at higher temperatures. Activation energy values, calculated in the range of 20 to 200° C. for air sintered and quenched pellets, are in the range of 0.31 to 0.34 eV.

The Na₃GdSi₃O₉ glass ceramic disclosed herein has a higher density and higher conductivity than previously described Na₃GdSi₃O₉, indicating that it has a different and novel structure. Given the conductivity values obtained, this ceramic may be useful as a solid-state electrolyte. In order to understand the electrochemical stability of Na₃GdSi₃O₉, galvanostatic experiments were performed at room temperature. A coin cell was assembled with the configuration Na/Na₃GdSi₃O₉/Na and stripping-plating cycles were repeated for 100 cycles at a current density of 0.01 mA cm⁻². FIG. 7 illustrates the stable voltage at the positive and negative sides indicating the electrochemical stability of Na₃GdSi₃O₉ with the sodium electrode.

While the NaMSiO ceramic been described in conjunction with the disclosed embodiments which are set forth in detail above, it should be understood that this is by illustration only and the NaMSiO ceramic is not intended to be limited to this embodiment. On the contrary, this disclosure is intended to cover alternatives, modifications, and equivalents which will become apparent to those skilled in the art in view of this disclosure.

1. A solid electrolyte having the chemical composition NaₓMₓSiₓ0ₓ, wherein M is Gd or Y, wherein x is an integer between 1 and 10, characterized in that it has a conductivity of at least 10⁻⁴ Scm⁻¹ at 20° C., and is electrochemically stable at a current density of 0.01 mA cm⁻² for at least 100 cycles.

2. The electrolyte of claim 1 having the chemical composition NaₓGdₓSiₓ0ₓ.

3. The electrolyte of claim 1 having the chemical composition Na₃GdSi₃O₉.

4. The electrolyte of claim 1 having the chemical composition Na₄GdSi₃O₉.

5. The electrolyte of claim 1 having the chemical composition NaₓYₓSiₓ0ₓ.

6. The electrolyte of claim 1 having the chemical composition Na₃YSi₃O₉.

7. The electrolyte of claim 1 having a PXRD pattern as shown in FIG. 2.

8. The electrolyte of claim 1 having a PXRD pattern with characteristic peaks at 22, 33 and 34 two theta.

9. The electrolyte of claim 1 having an Archimedes density of about 3.4 gcm⁻³.

10. The electrolyte of claim 1 wherein the electrolyte is produced by the following method:
a) mixing a mixture of precursors comprising sodium, silicon, oxygen and gadolinium for about 6 hours at about 200 rpm in high energy ball mill, optionally with additional sodium compound;
b) heating the mixture to about 900° C. for about 6 hours;
c) mixing the resultant mixture in high energy ball mill in an organic solvent for about 6 hours at about 200 rpm;
d) pressing a resultant powder into pellets by isostatic pressing;
e) heating the pellets for about 6 hours at about 1050° C. with a heating rate of about 5° C. per minute; and
f) air sintering or quenching the pellets.

11. The method of claim 10, wherein the compounds comprising sodium, silicon, oxygen and gadolinium are NaNO₃, Gd₂O₃ and SiO₂, and the solvent is isopropanol.

12. The use of the solid electrolyte of claim 1 as a membrane electrolyte in electrochemical and battery applications.

13. A battery comprising the solid electrolyte of claim 1.
